(19) United States
(12) Patent Application Publication
(10) Pub. No.: US 2009/0313424 A1
(43) Pub. Date: Dec. 17, 2009

(54) MEMORY DEVICE AND METHOD FOR SECURE READOUT OF PROTECTED DATA

(75) Inventors: Lubomir PLAVEC, Necin (CZ); Michal PRAZAN, Praha 3 (CZ); Ondrej SUBRT, Hradec Kralove 6 (CZ)

Correspondence Address: SUGHRUE MION, PLLC, 2100 PENNSYLVANIA AVENUE, N.W., SUITE 800, WASHINGTON, DC, 20037, US

(73) Assignee: EM Microelectronics-Marin S.A., Marin (CH)

(21) Appl. No.: 12/480,248

(22) Filed: Jun. 8, 2009

(30) Foreign Application Priority Data
Jun. 13, 2008 (EP) 08158260.3

(51) Int. Cl. G06F 12/02

(52) U.S. Cl. 711/103; 711/104; 711/E12.008; 711/E12.007

(57) ABSTRACT

The invention relates to a memory device, preferably a non-volatile memory device, comprising a memory array (16) with multiple memory cells (18) for storing bits of data, the memory cells (18) being arranged in word lines and columns, and a readout circuit (20) for reading out data from the memory array (16).

In order to enable an effective use of resources, it is proposed to further provide the non-volatile memory device with at least two sense amplifier devices (22, 24), wherein the sense amplifier devices (22, 24) are connected to respectively different subsets of memory cells of one of the word lines.

This application claims priority from European Patent Application No. 08158260.3 filed Jun. 13, 2008, the entire disclosure of which is incorporated herein by reference.

### FIELD OF THE INVENTION

The invention relates to a memory device, in particular a non-volatile memory device, comprising a memory array and a readout circuit and to a method for secure readout of protected data from such a memory device.

### BACKGROUND OF THE INVENTION

Non-volatile memory devices such as EEPROM, FLASH, ROM, FERRO-MEM, MRAM, HDD etc. and volatile memory devices such as static random access memory (SRAM) or dynamic random access memory (DRAM) devices are widely known for storing secret and non-secret data. Secret data is stored in many applications using passwords, keys and the like.

In conventional memory devices, the power consumption of the memory during reading a bit with the value 1 is slightly different from the power consumption during reading a bit with the value 0.

This results in the problem that upon reading the secure data, the measuring of the power consumption of the memory device can be used to obtain the secret data from the chip. This technique is called simple power analysis (SPA). If the power consumption is measured several times and average power consumption is calculated to suppress the random variations of the power consumption, the corresponding technique is called differential power analysis (DPA).

This type of attack is known since a long time and several proposals for preventing such attacks have been made. According to a first type of SPA/DPA protection, it has been proposed to try modifying a sense amplifying device of the memory device such that it has the same power consumption during reading 0's and reading 1's. A second proposal consists in doubling the memory and to use two chips, such that every bit may be written and read twice. In the first memory device, the bit value itself is stored and in the second memory device, its inverse value is stored, such that always one bit with the value 1 and one bit with the value 0 are read at the same time. As a consequence, the power consumption of entire structure can be made roughly independent on the memory content being read.

In the above mentioned first type of SPA/DPA protection, it has turned out to be very difficult to provide hardware having the same power consumption during reading 0's and 1's, since the power consumption profile can change with temperature, supply voltage and other external influences. If two memory devices are used, the unavoidable tolerances may result in a possible point for a DPA attack. Moreover, doubling all of the bits in a memory causes a significant increase of the area of the memory block.

In the most common applications, the memory device, e.g. a non-volatile memory device, is used to store non-secret data together with secret data. The efforts for protecting the readout of non-secure data against SPA/DPA attacks are unnecessary and result in an ineffective use of resources.

It is the object of the invention to provide a memory device enabling an effective prevention of SPA/DPA attacks while enabling an effective use of the resources.

### SUMMARY OF THE INVENTION

The object is achieved in particular by a memory device according to claim 1 and by a method for reading out protected data according to claim 10.

A first aspect of the invention relates to a memory device comprising a memory array with multiple memory cells for storing bits of data. The memory cells are arranged in word lines and columns. The memory device further comprises a readout circuit for reading out data from the memory array. It is proposed to provide the non-volatile memory device with at least two sense amplifier devices, wherein the sense amplifier devices are connected to respectively different subsets of memory cells of one of the word lines.

In contrast to common memory devices, where each word line is associated to one sense amplifier for amplifying the signals from this word line, the invention proposes to divide the word line into two or more subsets of memory cells each being associated and connected to a respectively different sense amplifier. The provision of two or more sense amplifiers enables a simultaneous readout from the different subsets of memory cells of the word line. On the one hand, protected data may be read in a SPA/DPA-proof way provided that the protected data is stored in a first part of the word line, i.e. in memory cells belonging to a first subset of memory cells of the word line, and the inverse copy of the protected data is stored in the second part i.e. in a second subset of memory cells of the same word line, said part being associated to a different sense amplifier. On the other hand, non-protected data may be simultaneously read out from the different regions of the word line in order to accelerate the readout for the non-protected data. As a consequence the twofold readout structure may be effectively used also for non-protected data.

According to a preferred embodiment of the invention, the memory device is a non-volatile memory device, such as for example a FLASH memory device.

The SPA/DPA-proof readout may be executed if the readout circuit is configured to simultaneously read out one first data bit of a first part of the word line using a first sense amplifier and one second data bit from a second part of the same word line using a second sense amplifier and if the first data bit is protected data bit and the second data bit is an inverse copy of the first data bit.

Correspondingly, it is proposed that the different subsets of memory cells of one of the word lines include a first subset of protected memory cells for storing protected data bits and a second subset of protected memory cells for storing an inverse copy of the protected data bits. The protected memory cells may be constructed with reduced temperature sensitivity and/or reduced tolerances compared to non-protected memory cells.

A corresponding write circuit may be configured to always automatically write the bit value and its inverse. Alternatively, the write procedure may be implemented in the application software.

However, the protected and the non-protected data bits may also have the same semiconductor-structure.

In a particularly simple embodiment of the invention, at least a part of the word lines is divided into half word lines, and the two half word lines of one line constitute the different subset of memory cells of the word line being connected to different sense amplifier devices. In general, the entire memory may be divided into two halves each being connected to one of the sense amplifier devices.

Moreover, it is proposed that the memory array comprises a protected subset of memory cells for storing protected data and an inverse copy of the protected data and further comprises a non-protected subset of memory cells for storing non-protected data. The size of the protected part of the memory may then be adapted such that ineffective use of the resources may be avoided.

In a particularly favourable embodiment of the invention, it is proposed that the readout circuit is configured to simultaneously read out two bits of the non-protected data from the non-protected subset of the memory cells using the at least two sense amplifiers in an accelerated reading mode. In a normal reading mode, the readout circuit may be configured to sequentially read out the bits of non-protected data from a third subset of the memory cells by employing the at least two sense amplifiers sequentially or alternatingly.

Moreover, it is proposed that the memory device further comprises a control device for adapting the size of the protected and non-protected parts of the memory device dependent on the amount of protected data to be stored. The control device may be a computer comprising the non-volatile memory device, wherein the computer runs a secure application using some type of protected data. The application may adapt the size of the protected and non-protected parts of the memory cells depending in the size of the protected data.

In particular, the control device may adapt the size of the protected and non-protected subsets of the memory cells by allocating word lines of the memory array to the protected subset or to the non-protected subset of the memory cells.

A further aspect of the invention relates to a method for secure readout of protected data from a memory device comprising a memory array with multiple memory cells for storing bits of data. The memory cells are arranged in word lines and columns.

It is proposed that the method comprises simultaneously reading out data bits from different subsets of memory cells of one of the word lines using at least two sense amplifier devices. The sense amplifier devices are connected to these different subsets of memory cells of the same word line respectively.

In a particularly favourable embodiment of the method according to the invention, it is proposed that the protected data bits and an inverse copy of these protected data bits are simultaneously read out from the different subsets of memory cells of the same word line, e.g. in order to avoid possible SPA/DPA attacks.

Further characterizing features of the invention and the advantages thereof will become apparent from the following description of a preferred embodiment of the invention. The embodiment and the figures illustrating the embodiment show a particular combination of the characterizing features of the invention. However, the invention is not limited to this particular combination and may be easily adapted by the skilled person to be applied in different environments or applications by considering further combinations or sub-combinations of the characterizing features.

### BRIEF DESCRIPTION OF THE DRAWINGS

FIG. 1 shows a computer system including a non-volatile memory device according to the invention; and

FIG. 2 is a schematic representation of a non-volatile memory device including two sense amplifier devices.

### DETAILED DESCRIPTION OF THE PREFERRED EMBODIMENTS

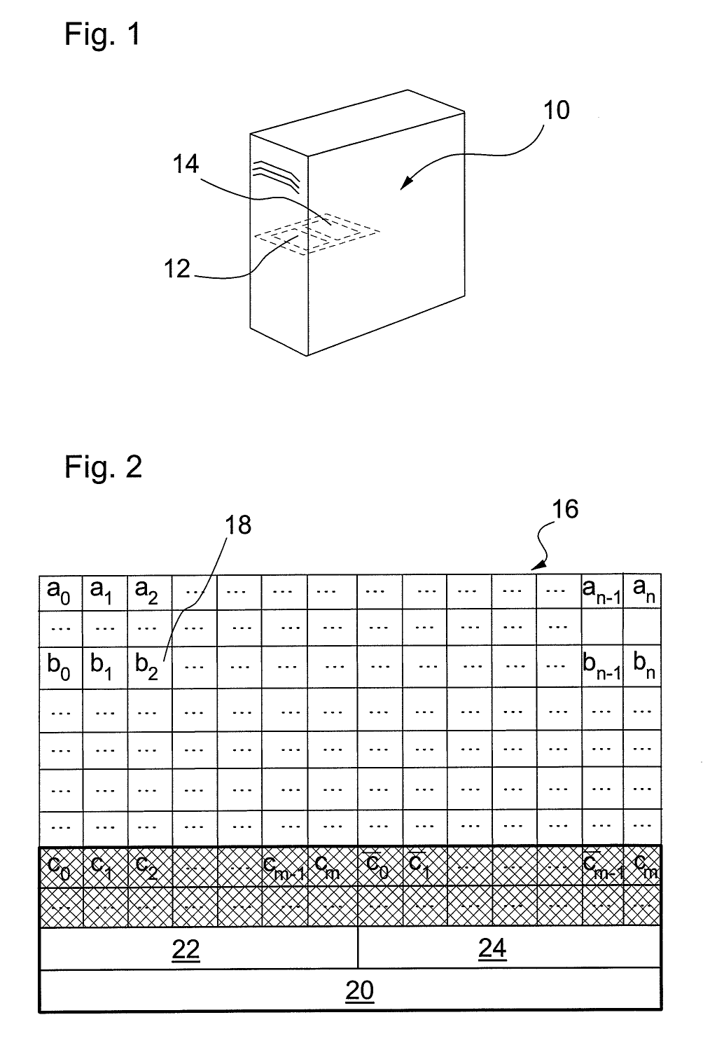

FIG. 1 is a schematic representation of a computer 10 including a non-volatile memory device in the form of a memory chip 12, in the present example a non-volatile memory device, and a central processing unit 14. The computer 10 runs a secure application employing protected data such as passwords.

The protected data is stored together with other data in the non-volatile memory device.

FIG. 2 is a schematic representation of the non-volatile memory device of FIG. 1. The non-volatile memory device comprises a memory array 16 with multiple memory cells 18 for storing bits of data. The memory cells are arranged in a rectangular matrix of word lines and columns. The non-volatile memory device further comprises a readout circuit 20 for reading out data from the memory array 16.

According to the invention, the non-volatile memory device comprises two sense amplifier devices 22, 24, namely a left hand sense amplifier device 22 and a right hand sense amplifier device 24. The sense amplifier devices 22, 24 have the well-known structure of regenerative sense amplifiers including PMOS isolation transistors and are used to amplify the memory device's sense bit-lines-swings between 100 mV and 300 mV to the full swing voltage of between 2 and 3 V.

In the embodiment shown in FIG. 2, the two sense amplifiers 22, 24 are connected to respectively different halves of the memory array 16, wherein each half includes half of the columns of the memory array 16, whereas the lines extend over both halves. Accordingly, each line is divided in two half lines, each half line being connected to one of the sense amplifiers 22, 24.

The readout circuit 20 is configured to simultaneously read out data bits from both halves of the same word line using the two sense amplifier devices 22, 24.

The readout circuit 20 is capable of performing the readout in three different operation modes. The first operation mode is a secure operation mode in which the readout circuit 20 reads out protected data bits from a first half of a word line and an inverse copy of the protected data bits from the second half of the protected word line using the two sense amplifiers 22, 24 simultaneously. In the secure mode, the readout circuit 20 always reads one bit with the value 1 and one bit with the value 0 simultaneously such that the total power consumption of the non-volatile memory device is independent of the bit-value of the protected data. As a consequence, SPA/DPA attacks are prevented.

The central processing unit 14 of the computer 10 of FIG. 1 is a control device which allocates a protected subset of the memory cells in the memory array 16 dependent on the amount of protected data to be stored. The control device may adapt the size of the protected subset depending on the secure application to be used. If more than one secure application is run, the respectively needed protected memory spaces may be added.

In a corresponding write mode for secure writing, the control device may simultaneously write the bit values of the protected data and the inverse thereof to the different halves of the protected word lines.

In the schematic representation of FIG. 2, the protected memory cells are highlighted with a hatching. It is illustrated that the protected line stores Boolean variables c₀-cₘ in its left half word line being associated to the left sense amplifier 22, whereas an inverse copy of the Boolean variables \vec{c}ₒ-\vec{c}ₘ are stored in the right half of the protected line. The right half of the protected line is associated to the right sense amplifier 24. Of course, the sense amplifier devices 22 and 24 may consist of plural individual sense amplifiers.

In a normal reading mode, the readout circuit 20 sequentially reads out the bits of the non-protected data from the non-protected subset of the memory cells using the two sense amplifiers. In the non-protected subset of the memory cells, the values of the bits being stored in the left halves of the word lines are independent of the values of the bits stored in the right halves of the word lines. The values of the non-protected Boolean variables are a₀-aₙ, and b₀-bₙ in FIG. 2, respectively. In the embodiment of FIG. 2, n=2m+1.

The central processing unit 14 and the readout circuit 20 implement a method for secure readout of the protected data from the non-volatile memory device according to FIG. 2. In a secure readout mode, the data bits from the different subsets of one of the word lines (the protected line) are simultaneously read using the two sense amplifier devices 22, 24 connected to the different subsets of memory cells of the word line, respectively. The protected data are written to the protected memory cells such that the data on the right half of the protected word line are bitwise inverse copies of the protected data written on the left halves of the word line.

In a third accelerated reading mode, the readout circuit 20 reads out bits from the two halves of the non-protected word lines (e. g. the values aₖ and aₘ₊ₖ) using the two sense amplifier devices 22, 24 simultaneously and in parallel.

1. A memory device comprising a memory array with multiple memory cells for storing bits of data, the memory cells being arranged in word lines and columns, and a readout circuit for reading out data from the memory array, wherein the memory device further comprises at least two sense amplifier devices, wherein the sense amplifier devices are connected to respectively different subsets of memory cells of one of the word lines, wherein said readout circuit is configured to simultaneously read out one first data bit of a first subset of memory cells of one word line using a first sense amplifier device and one second data bit from a second subset of memory cells of the same word line using a second sense amplifier device, said first data bit being a protected data bit and said second data bit being an inverse copy of the first data bit.

2. The memory device according to claim 1, wherein it is a non-volatile memory device, preferably a FLASH type memory device.

3. The memory device according to claim 1, wherein the different subsets of memory cells of one of the word lines include a first subset of protected memory cells for storing protected data bits and second subset of protected memory cells for storing an inverse copy of the protected data bits.

4. The memory device according to claim 1, wherein at least a part of the word lines is divided into two half word lines, said half word lines constituting said different subsets of memory cells of the word line being connected to different sense amplifier devices.

5. The memory device according to claim 1, wherein the memory array is divided into two halves each being connected to one of the sense amplifier devices.

6. The memory device according to claim 1, wherein the memory array comprises a protected subset of memory cells for storing protected data and an inverse copy of the protected data and a non-protected subset of memory cells for storing non-protected data.

7. The memory device according to claim 6, wherein said readout circuit is configured to simultaneously read out two bits of non-protected data from the non-protected subset of the memory cells using the at least two sense amplifier devices at least in an accelerated reading mode.

8. The memory device according to claim 6, wherein said readout circuit is configured to sequentially read out the bits of non-protected data from the non-protected subset of the memory cells using the at least two sense amplifier devices at least in a normal reading mode.

9. The memory device according to claim 6, characterized by further comprising a control device for adapting the size of the protected and non-protected subsets of the memory cells to the amount of protected data to be stored.

10. The memory device according to claim 9, wherein said control device is configured to adapt the size of the protected and non-protected subsets of the memory cells by allocating word lines of the memory array to the protected subset or to the non-protected subset of the memory cells.

11. A method for secure readout of protected data from a memory device, preferably a non-volatile memory device, comprising a memory array with multiple memory cells for storing bits of data, the memory cells being arranged in word lines and columns, wherein the method comprises simultaneously reading out data bits from different subsets of memory cells of one of the word lines using at least two sense amplifier devices, wherein the sense amplifier devices are connected to the different subsets of memory cells of the same word line respectively, and protected data bits and an inverse copy of the protected data bits are simultaneously read out from the different subsets of memory cells of the same word line.
